(19) United States
(12) Patent Application Publication
(10) Pub. No.: US 2010/0073179 A1
(43) Pub. Date: Mar. 25, 2010

(54) Movement Monitor for Medical Patients

(75) Inventor: Ted R. Greene, Poway, CA (US)

Correspondence Address: HIGGS, FLETCHER & MACK LLP, 401 West A Street, Suite 2600, SAN DIEGO, CA, 92101, US

(73) Assignee: United Security Products, Inc., Poway, CA (US)

(21) Appl. No.: 12/238,334

(22) Filed: Sep. 25, 2008

(51) Int. Cl. G08B 21/00

(52) U.S. Cl. 340/666

(57) ABSTRACT

A movement monitor includes a slipcover for enclosing a sensor pad and a flap pocket that extends from the slipcover. A compartment is formed in the flap pocket for securing a circuit board inside the flap pocket.

### BACKGROUND OF THE INVENTION

1. Field of the Invention

The present invention is directed generally to devices for detecting when a medical patient rises from a wheelchair or a bed and sounding an alarm to notify caregivers who may not be in the room. More specifically, but without limitation thereto, the present invention is directed to a movement monitor that integrates the alarm with the sensing device.

2. Description of Related Art

Medical patients who are confined to a wheelchair or a bed may attempt to stand and walk without assistance from their wheelchair or bed, resulting in falls that may result in serious injury and even death if not immediately treated. In previous devices that address this problem, a sensing device (or sensor pad) is placed on the wheelchair or bed where the patient's body rests. The sensor pad is attached by several feet of wire to an alarm box placed nearby that sounds an alarm when the patient's weight is removed from the sensor pad.

### SUMMARY OF THE INVENTION

In one embodiment, a movement monitor includes a slipcover for enclosing a sensor pad and a flap pocket that extends from the slipcover. A compartment is formed in the flap pocket for securing a circuit board inside the flap pocket.

### BRIEF DESCRIPTION OF THE DRAWINGS

The above and other aspects, features and advantages will become more apparent from the description in conjunction with the following drawings presented by way of example and not limitation, wherein like references indicate similar elements throughout the several views of the drawings, and wherein:

FIG. 1 illustrates a top view of a movement monitor for medical patients;

FIG. 2 illustrates a front view of the movement monitor of FIG. 1 as used with a wheelchair;

FIG. 3 illustrates a rear view of the movement monitor of FIG. 1 as used with a wheelchair and more particularly the placement of the pocket flap of the movement monitor in a wheelchair;

FIG. 4 illustrates a perspective view of a sensor pad for the movement monitor of FIG. 1; and

FIG. 5 illustrates a side view of a circuit board inside the pocket flap of FIG. 1.

Elements in the figures are illustrated for simplicity and clarity and have not necessarily been drawn to scale. For example, the dimensions, sizing, and/or relative placement of some of the elements in the figures may be exaggerated relative to other elements to clarify distinctive features of the illustrated embodiments. Also, common but well-understood elements that may be useful or necessary in a commercially feasible embodiment are often not depicted in order to facilitate a less obstructed view of the illustrated embodiments.

### DESCRIPTION OF THE ILLUSTRATED EMBODIMENTS

The following is a description of specific examples that embody general principles from which other embodiments may be derived. Accordingly, the illustrated embodiments are not intended to exclude other embodiments that may be derived from the same general principles within the scope of the appended claims. For example, certain actions or steps may be described or depicted in a specific order to be performed. However, practitioners of the art will understand that the specific order is only given by way of example and that the specific order does not exclude performing the described steps in another order to achieve substantially the same result. Also, the terms and expressions used in the description have the ordinary meanings accorded to such terms and expressions in the corresponding respective areas of inquiry and study except where other meanings have been specifically set forth herein.

A typical movement monitor includes a sensing device or sensor pad for placement on a wheelchair or bed connected to an alarm box by several feet of wire. The alarm box sounds an alarm when the patient's body weight is removed from the sensor pad. A problem with this arrangement is that the wire may easily catch on nearby objects and may even pose a choking hazard or other risk factor to the disabled patient. Also, the alarm box may fall and be damaged or disconnected from the sensor pad. A movement monitor that advantageously avoids these problems and that may provide other advantages is described as follows.

In one embodiment, a movement monitor includes a slipcover for enclosing a sensor pad and a flap pocket that extends from the slipcover. A compartment is formed in the flap pocket for securing a circuit board inside the flap pocket.

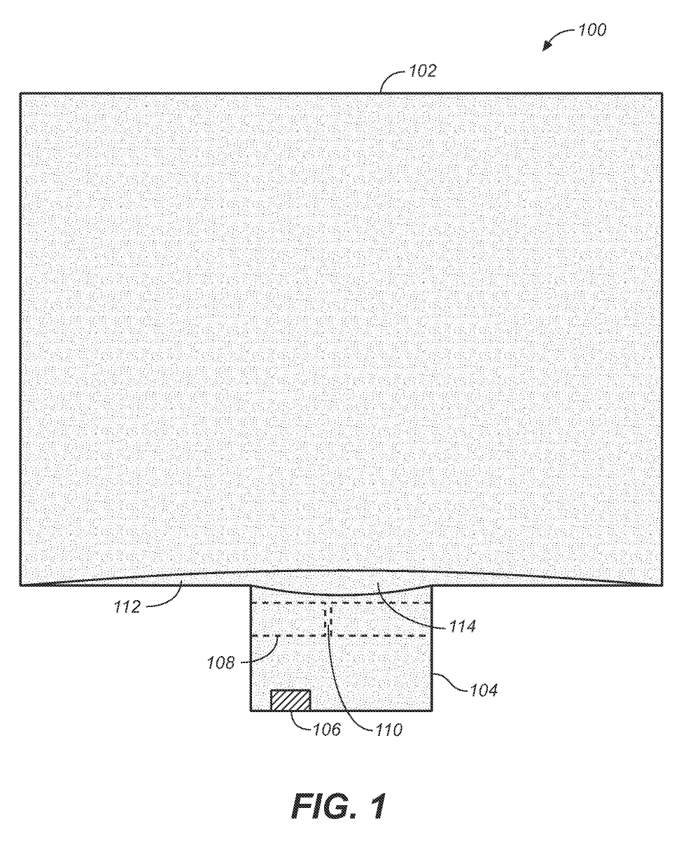

FIG. 1 illustrates a top view 100 of a movement monitor for medical patients. Shown in FIG. 1 are a slipcover 102, a pocket flap 104, a switch locator 106, compartment stitching 108, a wire tunnel 110, a slip cover opening 112, and a pocket flap opening 114.

In the embodiment of FIG. 1, the slipcover 102 is dimensioned to fit on the seat of a wheelchair so that the slipcover 102 is prevented from slipping forward by the front posts that support the armrests of the wheelchair and from slipping backward by the rear posts that support the back of the wheelchair. In one embodiment, the slipcover 102 is made of two rectangular pieces of felt or heavy cloth sewn along three sides, leaving the slipcover opening 112 to enclose a sensor pad (not shown) inside the slipcover 102. In another embodiment, the slipcover 102 includes fasteners such as snaps along the edge of the slipcover opening 112 to secure the sensor pad inside the slipcover 102. Other types of fasteners may be used to fasten the edge of the slipcover opening 112, for example, Velcro™, to practice various embodiments within the scope of the appended claims.

In one embodiment, both the top and bottom pieces of the slipcover 102 are cut out together from two layers of fabric in the shape of a rectangle that includes a rectangular extension as shown in FIG. 1. The rectangular extension on the upper piece may be cut off and sewn to the rectangular extension on the lower piece to form the pocket flap 104, leaving the flap pocket opening 114 facing the slipcover opening 112 as shown in FIG. 1. The pocket flap 104 encloses a circuit board that is connected to the sensor pad inside the slipcover 102 by a wire routed through the wire tunnel 110. The wire tunnel 110 may be formed, for example, by stitching along a portion of the pocket flap opening 114 leaving a gap for the wire from the sensor pad as shown in FIG. 1. The stitching for the wire tunnel 110 may be added after the circuit board is inserted in the pocket flap 104 and connected to the wire from the sensor pad.

The circuit board may be, for example, the same the circuit board typically used in movement detectors in which the circuit board is enclosed in a plastic box connected to a sensor pad by several feet of wire. The weight of the circuit board inside the pocket flap 104 is preferably light enough not to let the slipcover 102 slide off the seat of the wheelchair when there is no body weight resting on the slipcover 102. On the other hand, the weight of the circuit board in the pocket flap 104 helps keep the slipcover 102 from sliding forward in the wheelchair when patients rise from the wheelchair. In FIG. 1, the circuit board is held securely in place inside the pocket flap 104 by the compartment stitching 108. The compartment stitching 108 may be added after the circuit board is inserted in the pocket flap 104 and connected to the wire from the sensor pad.

In one embodiment, the circuit board includes an audible alarm. The audible alarm may be, for example, a pulsing sound or a recorded voice that warns the patient that he or she should not stand or walk alone. In another embodiment, the circuit board includes a wireless transmitter that sounds an alarm at a remote location, for example, at a nurses' station, or caregiver's cell phone. The pocket flap 104 also helps hold the slipcover 102 in place on the seat when the pocket flap 104 hangs below the back of the seat of a wheelchair or over a bed rail. The location of the pocket flap 104 behind the seat of a wheelchair is not easily accessible by someone sitting in the wheelchair, which helps prevent a patient from intentionally switching the unit off. In another embodiment, the flap is elongated so that it hangs over the side of a bed beyond the reach of a patient lying on the bed. The pocket flap 104 may be folded over or under the slipcover 102 for conveniently storing the movement monitor on a shelf or in a cabinet.

In one embodiment, the switch locator 106 includes a patch on the outside surface of the pocket flap 104 having a different color than that of the pocket flap 104 to provide a visual indication of the location of the switch that activates the circuit board. In another embodiment, the switch locator 106 includes a tactile feature such as texture or thickness so that the switch on the circuit board inside the pocket flap 104 may be conveniently located and switched by a caregiver from outside the flap pocket 104.

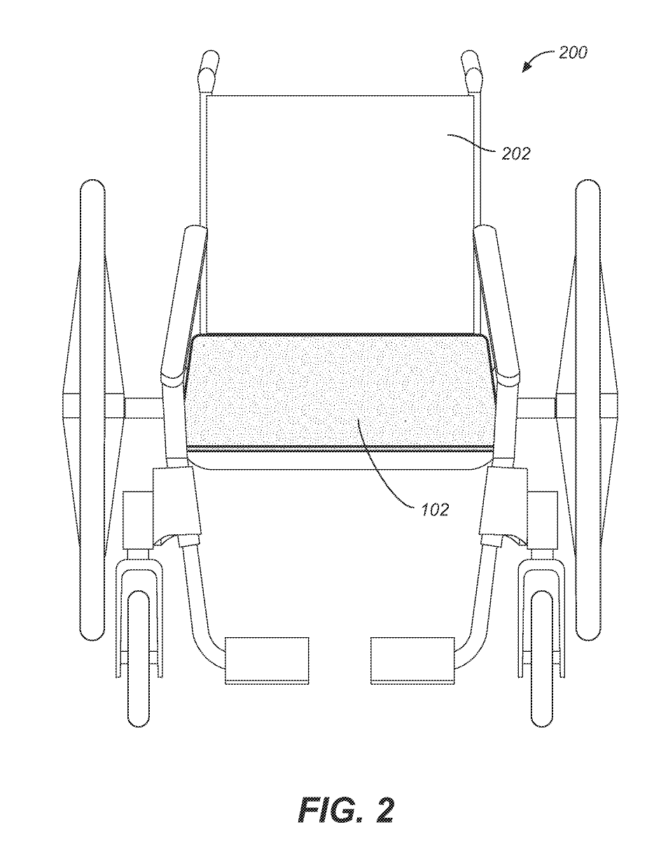

FIG. 2 illustrates a front view 200 of the movement monitor of FIG. 1 as used with a wheelchair. Shown in FIG. 2 are a slipcover 102 and a wheelchair 202.

In the embodiment of FIG. 2, the slipcover 102 fits on the seat of the wheelchair 202 so that it is constrained from slipping forward or backward from the front posts that support the armrests and by the back posts that support the back of the wheelchair 202.

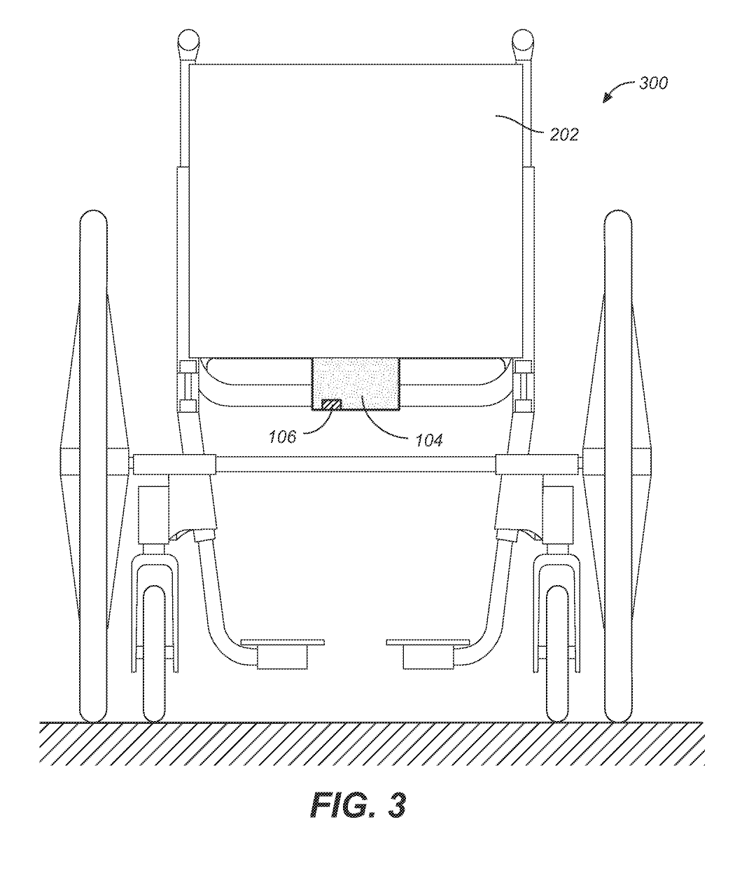

FIG. 3 illustrates a rear view 300 of the movement monitor of FIG. 1 as used with a wheelchair. Shown in FIG. 3 are a pocket flap 104, a switch locator 106, and a wheelchair 202.

In the embodiment of FIG. 3, the pocket flap 104 is inserted between the seat and the back of the wheelchair 202 so that the pocket flap 104 hangs down behind the back of the wheelchair 202. The switch locator 106 indicates the location of the switch on the circuit board inside the pocket flap 104. The switch may be conveniently switched on or off from the outside of the pocket flap 104 by a caregiver, while remaining generally inaccessible to a patient sitting in the wheelchair 202.

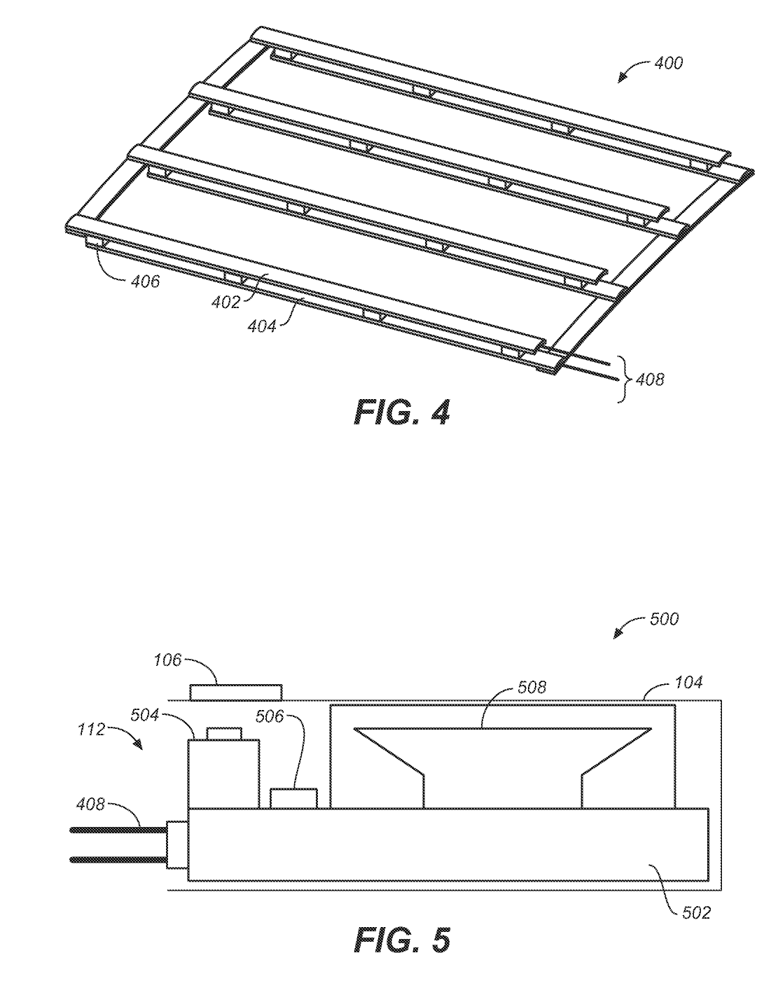

FIG. 4 illustrates a perspective view 400 of a sensor pad for the movement monitor of FIG. 1. Shown in FIG. 4 are an upper contact 402, a lower contact 404, insulating spacers 406, and contact wires 408.

In the embodiment of FIG. 4, the upper contact 402 and the lower contact 404 are each made of strips of a resilient, electrically conductive material such as stainless steel and arranged in a vertically parallel pattern. In one embodiment, the parallel strips have a width of about 2 cm, a length of about 35 cm, and a thickness of about 0.1 mm. In one embodiment, the parallel strips have a curved cross-section that increases the return force that straightens and separates the strips when a weight that presses the strips together to make electrical contact with each other is removed from the sensor pad. Insulating spacers 406 separate the contacts 402 and 404 at intervals of about 8 cm so that the contacts 402 and 404 do not make electrical contact with each other when no weight is present to press them together. The insulating spacers 406 may be made of, for example, squares of a double-sided urethane tape having about the same width as the contacts 402 and 404 and a thickness of about 2 mm. Other materials and dimensions may be used to make the insulating spacers 406 according to well-known techniques within the scope of the appended claims. The contacts 402 and 404 each are arranged in a parallel grid that is connected at one end by a flat strip of an electrically conductive material such as stainless steel. The spacing between adjacent pairs of contacts 402 and 404 in the grid may be, for example, about 5 cm. One end of each of the contact wires 408 is connected respectively to the contacts 402 and 404. The opposite ends of the contact wires 408 are passed through the wire tunnel 110 for connecting to the circuit board in the pocket flap 104 of FIG. 1.

In one embodiment, the sensor pad of FIG. 4 is enclosed in a vinyl sleeve according to well-known techniques to provide mechanical stability and flexibility for the sensor pad and to protect the contacts 402 and 404 from exposure to moisture and foreign objects. In another embodiment, the vinyl sleeve and the contacts 402 and 404 are enclosed in a foam cushion for added comfort.

Sensor pads are typically discarded by hospitals within 30 days. Because the sensor pad and the circuit board in the movement monitor of FIG. 1 may last up to a year or more, the movement monitor may be packaged with a prepaid mailer envelope addressed to the manufacturer or to a distributor for convenient disposal and recycling.

FIG. 5 illustrates a side view 500 of a circuit board 502 inside the pocket flap of FIG. 1. Shown in FIG. 5 are a pocket flap 104, a switch locator 106, contact wires 408, a circuit board 502, a switch 504, a battery 506, and a loudspeaker 508.

In the embodiment of FIG. 5, the contact wires 408 are connected by an electrical connector to the circuit board 502. The circuit board 502 includes components such as the switch 504, the battery 506, and the loudspeaker 508. The switch 504 switches the power from the battery 506 to the circuit board 502. The switch 504 may be, for example, a push-button switch, a toggle switch, a slide switch, a rocker switch, or other type of switch to practice various embodiments within the scope of the appended claims. The switch 504 may be conveniently located from outside the pocket flap 104 of FIG. 1 by the switch locator 106.

The specific embodiments and applications thereof described above are for illustrative purposes only and do not preclude modifications and variations that may be made within the scope of the following claims.

What is claimed is:

1. A movement monitor comprising:
a slipcover for enclosing a sensor pad;
a flap pocket that extends from the slipcover; and
a compartment formed in the flap pocket for securing a circuit board inside the flap pocket.

2. The movement monitor of claim 1 comprising a switch locator fastened to the pocket flap to provide a visual indication of a location of a switch on the circuit board inside the flap pocket.

3. The movement monitor of claim 2 comprising the switch locator having a color different from that of the pocket flap.

4. The movement monitor of claim 2 comprising the switch locator having a tactile feature to provide a tactile indication of a location of a switch inside the flap pocket.

5. The movement monitor of claim 1 comprising the sensor pad.

6. The movement monitor of claim 5 comprising electrical contacts in the sensor pad that make electrical contact when a weight is placed on the sensor pad.

7. The movement monitor of claim 6 comprising a vinyl sleeve that encloses the sensor pad.

8. The movement monitor of claim 5, the sensor pad comprising a pair of parallel strips of an electrically conductive material separated at intervals by an insulating material so that the strips make electrical contact with each other when a weight rests on the sensor pad and break electrical contact with each other when the weight is not resting on the sensor pad.

9. The movement monitor of claim 8 comprising the parallel strips having a curved cross-section.

10. The movement monitor of claim 1 comprising a wire tunnel stitched in the flap pocket for connecting the circuit board to the sensor pad.

11. The movement monitor of claim 1 comprising stitching to form the compartment in the flap pocket.

12. The movement monitor of claim 1 comprising an opening in the slipcover facing the flap pocket for inserting the sensor pad into the slipcover.

13. The movement monitor of claim 12 comprising an opening in the flap pocket facing the opening in the slipcover for inserting the circuit board into the pocket flap.
